(19) United States
(12) Patent Application Publication
(10) Pub. No.: US 2005/0194444 A1
(43) Pub. Date: Sep. 8, 2005

(54) System for encoding information using colors

(76) Inventor: Harry A. Gieske, Silver Spring, MD (US)

Correspondence Address: Min, Hsieh & Hack LLP;c/o PortfolioIP, P.O. Box 52050, Minneapolis, MN, 55402, US

(21) Appl. No.: 11/071,618

(22) Filed: Mar. 3, 2005

Related U.S. Application Data
(60) Provisional application No. 60/549,367, filed on Mar. 3, 2004.

(51) Int. Cl. G06K 7/10

(52) U.S. Cl. 235/462.01; 235/462.04

(57) ABSTRACT

The present teachings relate to a method and system for recording information on polychromatic tiles or bars printed on arbitrarily colored substrates. The teachings provide a method for transmitting and/or recording information using diverse colors.

This application claims benefit of priority of U.S. Provisional Application No. 60/549,367, filed Mar. 3, 2004 and incorporated by reference herein.

### FIELD

The present teachings relate to a method and system for recording and reading information on polychromatic tiles or bars printed on arbitrarily colored substrates.

### INTRODUCTION

Information codes, such as bar codes, are simple to print and easy to read. For example, bar codes have been in widespread use on various commodities and commercial goods. In addition, bar codes have become widely used on other types of objects, such as identification cards, driver's licenses, passports, and the like. A bar code is generally formatted as a pattern of parallel bars and spaces of various widths that represent data elements or characters. The bars typically represent strings of binary ones (1's) and the spaces represent strings of binary zeros (0's). Generally, the bars and spaces can be no smaller than a specified minimum width which is called a “module” or “unit.” The bars and spaces are multiples of this module size or minimum width.

The conventional bar code symbol is “one-dimensional” in that the bars and spaces extend only in a single direction. There has been an increasing need, however, for machine-readable symbols that contain more information than conventional bar code symbols. One approach for increasing the information in machine-readable symbols is to reduce the height of the bar codes and stack the bar codes one on top of each other to create a “stacked” or “two-dimensional” bar code. One such two-dimensional bar code is “PDF417”, which was developed by Symbol Technologies, Inc. The PDF417 symbology utilizes a variable number of codewords which are discrete representations of data. A complete description of the PDF417 code is contained in U.S. Pat. No. 5,304,786. Other two dimensional bar code symbologies include “Code 1” and “Maxicode”, which are referred to as matrix codes.

Due to the binary nature of bar codes (i.e. the representation of logical 1's and 0's), both linear bar codes and two-dimensional bar code symbols are printed in two highly contrasting colors, which optimally are black bars printed on a white substrate such as a sheet of paper. The white spaces between the black bars provides a high contrast so that the bar/space edges can be readily detected by the scanner, and digitized and decoded in accordance with the particular symbology implemented. In some cases, product packaging dictates that different color pairs be used; e.g. on some beverage cans, gold and/or red may be used. In all cases, however, two contrasting colors are used to designate the two possible states of information being conveyed by the units of the bar code.

A characteristic of known barcodes is that they tend to be monochromatic, usually employing bars of a single color printed on a contrasting substrate. Typically the bars are black in color and the substrate is white in color, but other contrasting color combinations are possible. Known barcodes must have sufficient contrast between the bars and substrate so that a scanning device can “read” the sequence pattern of the barcode. Insufficient contrast between the printed bars and the substrate results in inaccurate interpretation. Unfortunately, monochromatic barcodes are limited in the amount of information they can represent within a given area of space.

In order to increase the information density over monochromatic barcodes, multi-colored bar code systems have been proposed. For example, U.S. Pat. No. 3,637,993 discloses a transition code recognition system, which uses a three color bar code in which transitions from a first color to a second color, from the second color to a third color, and from the third color to the first color manifest a first binary value, and in which transitions from the third color to the second color, from the second color to the first color, and from the first color to the third color manifest a second binary value. This bar code symbology is therefore transition or edge defined. Unfortunately, known multi-colored bar codes do not take full advantage of the use of colors.

### SUMMARY

In accordance with one aspect of the present disclosure, there is provided a barcode comprising a data region comprising a set of tiles. Each of the set of tiles is encoded with at least one of a plurality of colors. Each character of a set of characters is represented by a respective color. At least some of the plurality of colors represent combinations of characters from the set of characters.

According to another aspect of the present disclosure, there is provided a method of encoding information into a barcode. The barcode comprises a data region having a set of colored tiles. Each character of a set of characters is represented by a respective color, and at least some colors represent combinations of characters from the set of characters. Information to be encoded into the barcode is determined. Characters and combinations of characters are identified in the information. The respective colors that represent the identified characters and combinations of characters are selected. The data region is then formatted to include the set of colored tiles based on the selected colors.

According to another aspect of the present disclosure, there is provided a method of decoding information from a barcode. The barcode comprises a data region having a set of colored tiles. The data region of the barcode is read. The set of colored tiles in the data region are determined. A color of each of the set of colored tiles is determined. At least one of a character or a combination of characters represented by the color of each colored tile is then determined.

According to yet another aspect of the present disclosure, there is provided object that contains information. The object comprises at least one surface that provides an area for presenting at least some of the information. The object also comprises a barcode that encodes at least some of the information within a data region having a set of colored tiles. Each of the set of tiles is encoded with at least one of a plurality of colors. Each character in the information is represented by a respective color, and at least some of the plurality of colors represent combinations of characters from the set of characters.

It is to be understood that both the foregoing general description and the following description of various embodiments are exemplary and explanatory only and are not restrictive.

### BRIEF DESCRIPTION OF THE DRAWINGS

The accompanying drawings, which are incorporated in and constitute a part of this specification, illustrate various embodiments. The patent or application file contains at least one drawing executed in color. Copies of this patent or patent application publication with color drawings will be provided by the Office upon request and payment of the necessary fee. In the drawings,

FIG. 1 illustrates a schematic for implementing processes for creating and decoding a multi-colored barcode in accordance with the present teachings;

FIG. 2 illustrates an example of a multi-colored barcode that is consistent with the present teachings;

FIG. 3 illustrates an exemplary motor vehicle certificate that incorporates a multi-colored barcode that is consistent with the present teachings;

FIG. 4 illustrates an exemplary stock certificate that incorporates a multi-colored barcode that is consistent with the present teachings; and

FIG. 5 illustrates an exemplary page from a passport that incorporates a multi-colored barcode that is consistent with the present teachings.

### DESCRIPTION

The present teachings relate to methods and system for reading and recording information using a multi-colored barcode. The barcode may comprise a data region that includes a set of tiles. Each tile may be colored with a plurality of colors and at least one tile may represent characters, such as the letters “A” through “Z”, numbers, and symbols. A tile may also be colored to represent various combinations of characters, such as frequently used words, or combinations like “tion,” “ing,” “qu,” and the like.

The multi-colored barcode may be printed or affixed using a variety of known technologies. For example, the multi-colored barcode may be produced using well known ink-jet or laser printers. Alternatively, for sensitive objects or documents, such as passports, identification cards, certificates, the multi-colored barcode may be produced using specialized printers, such as those manufactured by Toppan Printing Company, Olympus Incorporated, or Hewlett-Packard Development Company, L.P.

The present teachings may be implemented based on well known hardware, software, firmware, or any combination thereof. For example, well known devices, such as scanners, solid state imagers, and charge-coupled devices (CCDs), may be used to scanning multi-colored barcodes that are consistent with the present teachings.

For example, the present teachings may use various scanners that include a light source for irradiating a barcode with light, such as white light. A scanning component, such as an oscillating mirror, may sweep the light in a horizontal and/or raster pattern across the multi-colored barcode. Collection optics in the scanner may include a photo sensor for sensing the light reflected off multi-colored bar code and convert the light energy into an analog or digital signal. The signal may then be processed to determine the data encoded into the multi-colored barcode.

As another example, the present teachings may be implemented in systems using two-dimensional CCD arrays to capture the multi-colored barcode. Alternatively, linear CCD arrays may be used to capture the image of the multi-colored barcode on a row-by-row basis, where the linear array is mechanically or optically scanned down across the rows of the multi-colored barcode. Accordingly, one skilled in the art will recognize that a wide variety of hardware, software, and the like may be used by the present teachings.

Reference will now be made to various exemplary embodiments, examples of which are illustrated in the accompanying drawings. Wherever possible, the same reference numbers are used in the drawings and the description to refer to the same or like parts.

The present disclosure provides for reading and recording information using a multi-colored barcode that comprises polychromic tiles or bars printed on a substrate, for example an arbitrarily colored substrate. More generally, the present disclosure provides a method for transmitting and/or recording information using diverse colors.

The element of information represented by a tile of the multi-colored barcode may be a character in an alphabet, a word or glyph in a written language, or any other predefined set of symbols to convey and/or record information. According to various embodiments, alphanumeric information is represented and recorded with printed “tiles,” e.g., squares or bars, each of a particular color. For example, known printers and scanners are typically capable of printing or scanning at least 256 discrete colors. In accordance with the present disclosure, by way of example, each of these 256 discrete colors is used to represent an alpha-numeric character in the English alphabet, or ASCII character set. In this particular case, the 256 colors are more than sufficient to represent the twenty-six letters and ten numbers used in the English alphabet. For example, a frequency f1 may be assigned as “a” and frequency f26 may be assigned as “z.” As a result, and in accordance with various embodiments, some of the 256 colors may be assigned to frequently occurring letter combinations, such as “the,” “of,” “ton,” “tion,” “qu,” “ing,” and the like.

According to various embodiments, since the color of each tile of the present invention represents an element of information, the tiles may be printed substantially next to each other. That is, in some embodiments, the multi-colored barcode may configure the tiles without a space or gap between tiles as would be the case in a monochromatic barcode. In other embodiments, the tiles of the multi-colored barcode may be read and processed in groups. For example, in some embodiments, pairs of tiles may be used to represent an element of information. Encoding information based on groups of tiles may be useful in order to simplify or reduce the number of colors required by the multi-colored barcode. Hence, the multi-colored barcode may use a reduced palette of 16 colors, and yet, still provide an encoding space of 256 characters and combinations. Thus, the present disclosure enables the recording of more information in the same physical area relative to known barcodes.

The term “color” may generally refer to that part of the electromagnetic spectrum that is discemable by the human eye. Detection of color, as performed by the human eye, or by a detector in a scanner or camera, is a reaction to received energy at a particular frequency or frequency band in the visible part of the electromagnetic spectrum. In other embodiments, the multi-colored barcode may use colors in other parts of the electromagnetic spectrum to represent elements of information.

The colors may be based on a frequency or frequency bands of the electromagnetic spectrum, wherein discrete frequencies and frequency bands correspond to a predefined element of information. The number and spacing between colors may be determined based on the desired information density of the barcode.

In some embodiments, the colors of these tiles may relate to characteristics that are discernable to the human eye, such as hue, brightness, and shade. For example, in some embodiments, the multi-colored barcode may use a set of 16 colors that are based on various combinations of red, green, and blue that are discernable to the human eye. Of course, one skilled in the art will also recognize that any number of colors may be used by the present teachings, even those that are not humanly discernable.

For purposes of illustration, table 1 is provided below to some examples of information colors and the information they may represent.

TABLE 1
Example Wavelength Color Conversion

| | | | | Color Component For Printing | | |
|---|---|---|---|---|---|---|
| | Hex | Binary | Decimal | Red | Green | Blue |
| Wavelength | Value | Value | Value | Component | Component | Component |
| Lambda 0 | 0 × 00 | 0000 | 0 | 0 × C0C | 0 × E0E0 | 0 × 2727 |
| Lambda 1 | 0 × 01 | 0001 | 1 | 0 × E3E3 | 0 × F4F4 | 0 × EBEB |
| Lambda 2 | 0 × 02 | 0010 | 2 | 0 × D9D9 | 0 × 1414 | 0 × C6C6 |
| Lambda 3 | 0 × 03 | 0011 | 3 | 0 × E2E2 | 0 × E7E7 | 0 × 303 |
| Lambda 4 | 0 × 04 | 0100 | 4 | 0 × 909 | 0 × 8B8B | 0 × AFAF |
| Lambda 5 | 0 × 05 | 0101 | 5 | 0 × 4545 | 0 × 202 | 0 × 5C5C |
| Lambda 6 | 0 × 06 | 0110 | 6 | 0 × 7373 | 0 × DFDF | 0 × A8A8 |
| Lambda 7 | 0 × 07 | 0111 | 7 | 0 × A2A2 | 0 × 4E4E | 0 × 606 |
| Lambda 8 | 0 × 08 | 1000 | 8 | 0 × E2E2 | 0 × 7070 | 0 × EAEA |
| Lambda 9 | 0 × 09 | 1001 | 9 | 0 × E3E3 | 0 × 6161 | 0 × 2727 |
| Lambda 10 | 0 × 0A | 1010 | 10 | 0 × 9191 | 0 × 5858 | 0 × A1A1 |
| Lambda 11 | 0 × 0B | 1011 | 11 | 0 × FFFF | 0 × B5B5 | 0 × 7777 |
| Lambda 12 | 0 × 0C | 1100 | 12 | 0 × 8F8F | 0 × CBCB | 0 × 707 |
| Lambda 13 | 0 × 0D | 1101 | 13 | 0 × C0C | 0 × ADAD | 0 × 8282 |
| Lambda 14 | 0 × 0E | 1110 | 14 | 0 × 2828 | 0 × 4848 | 0 × 1313 |
| Lambda 15 | 0 × 0F | 1111 | 15 | 0 × 4848 | 0 × CBCB | 0 × FEFE |

By using a set of frequencies to represent elements of information, information may be transmitted from one point to another using such means as radio waves and fiber optic cables. Instead of transmitting the information as digital (binary) data streams, the information may now be transmitted without conversion to a digital data stream.

The multi-colored barcodes of the present teachings may have many applications. As an example, the barcode can be placed on an encapsulated semiconductor chip in which the label contains, for example, serial number or ID, the company and its address and telephone number, the model number, place of manufacture, test data, application notes, schematic diagram, specification, optimal characteristics of off chip parts, price, customs data, and the like.

Other applications of the multi-colored barcode may include the coding of paper currency, documents and images as well as credit card labeling. Moreover drivers' licenses, passports, birth certificates, stock certificates, real property deeds, real property titles such as motor vehicle titles, identity documents, government benefit cards, certificates of naturalization, pharmaceuticals labeling, medical information cards, jewelry labeling, and packaging labeling in general are other examples of applications that may be within the scope of the present teachings.

In addition, the multi-colored barcode may include various security features to protect its information. For example, information in the barcode may be encrypted based on well known techniques. Other security features, such as holographic images and specialized inks, may also be used in accordance with the present teachings.

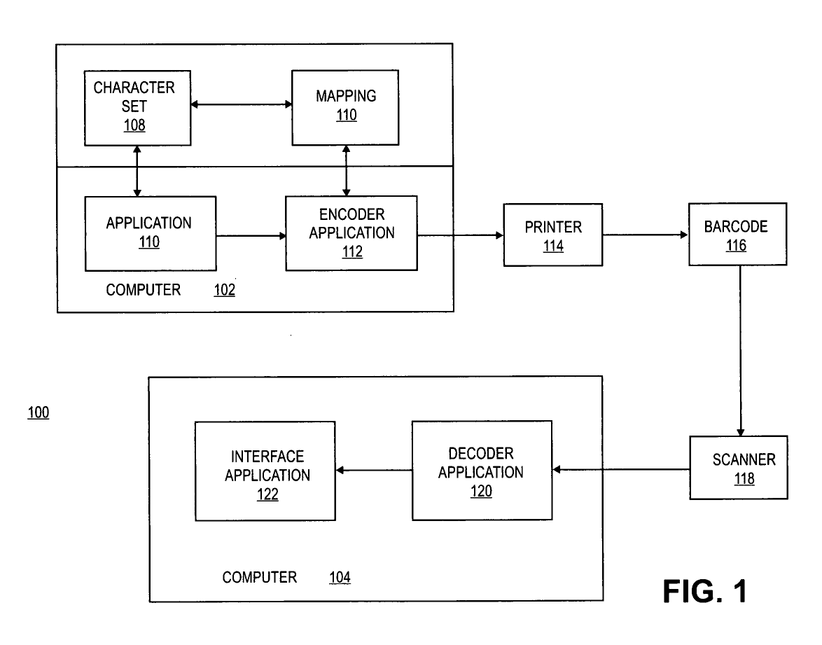

FIG. 1 illustrates a schematic for implementing processes for creating and decoding a multi-colored barcode in accordance with the present teachings. As shown, a system 100 may include various components to encode or decode a multi-colored barcode, such as computers 102 and 104. Computers 102 and 104 may be implemented using well known hardware and software. Although shown as separate devices, one skilled in the art will recognize that computers 102 and 104 may comprise any number of processors and devices. For example, in the embodiment shown in FIG. 1, computer 102 may be configured to encode information and produce the multi-colored barcode. Computer 102 may be a personal computer that is executing one or more software applications to provide these functions. Such a device is well known to those skilled in the art.

In particular, computer 102 may comprise a memory 106 that stores a set of information elements 108 and a mapping 110. Memory 106 may be implemented based on well known components, such as read-only memory and random-access memory. In addition, memory 106 may be coupled to a storage device (not shown), such as hard disk drive, or optical disk drive.

Set 108 represents the set of information elements such as letters of an alphabet, glyphs, words, or phrases. As noted, in some embodiments, set 108 may represent alphanumeric characters, such as “a” through “z” and “0” through “9”, as well as various combinations of these characters.

Mapping 110 provides a data structure for mapping the set of information elements in set 108 to the palette of colors used by system 100. For example, in some embodiments, mapping 110 may map the information elements of set 108 to a palette of 256 colors. In other embodiments, mapping 110 may map the information elements of set 108 to respective pairs of colors. Of course, one skilled in the art will recognize that any combination of characters may be mapped to any combination of colors in mapping 110.

Computer 102 may also include an application 110, for example a word processor. Application 110 may be used to construct and format the information to be encoded into the multi-colored barcode. The information to be encoded is constructed using the information elements in set 108.

Computer 102 may include an encoding application 112 to generate the colored tiles of the multi-colored barcode. In some embodiments, encoding application 112 is configured to generate colored tiles in a linear or two-dimensional array. The colored tiles may be of various sizes based on the amount of information to be encoded and the available area for the data region of the barcode.

Printer 114 may be coupled to computer 102 and produces the colored barcode 116 on to a tangible medium, such as paper or other type of substrate. Printer 114 may be implemented with well known devices, such as those noted above.

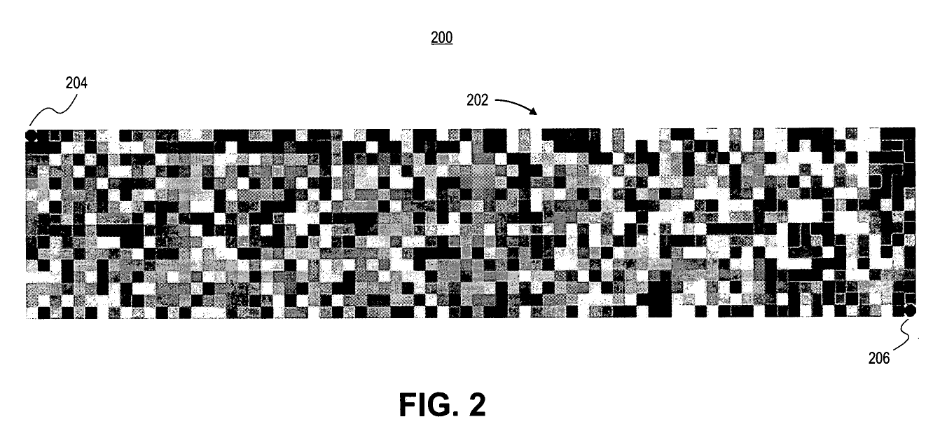

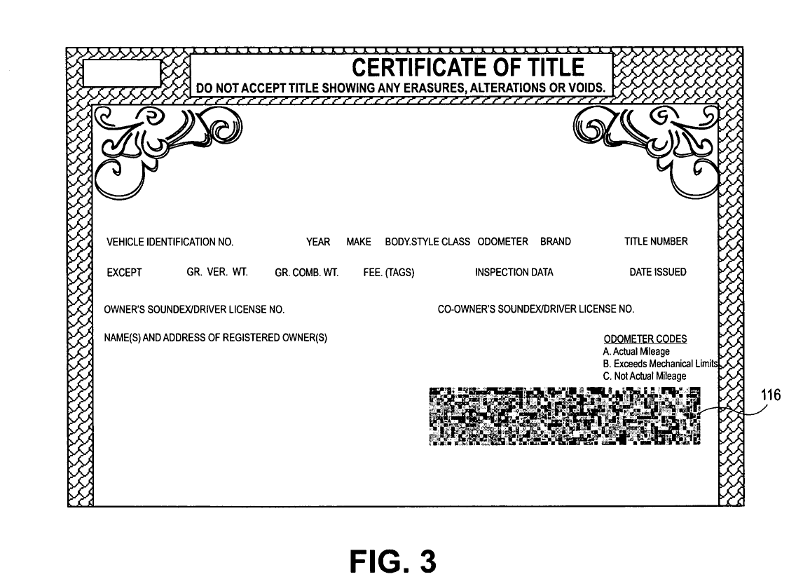

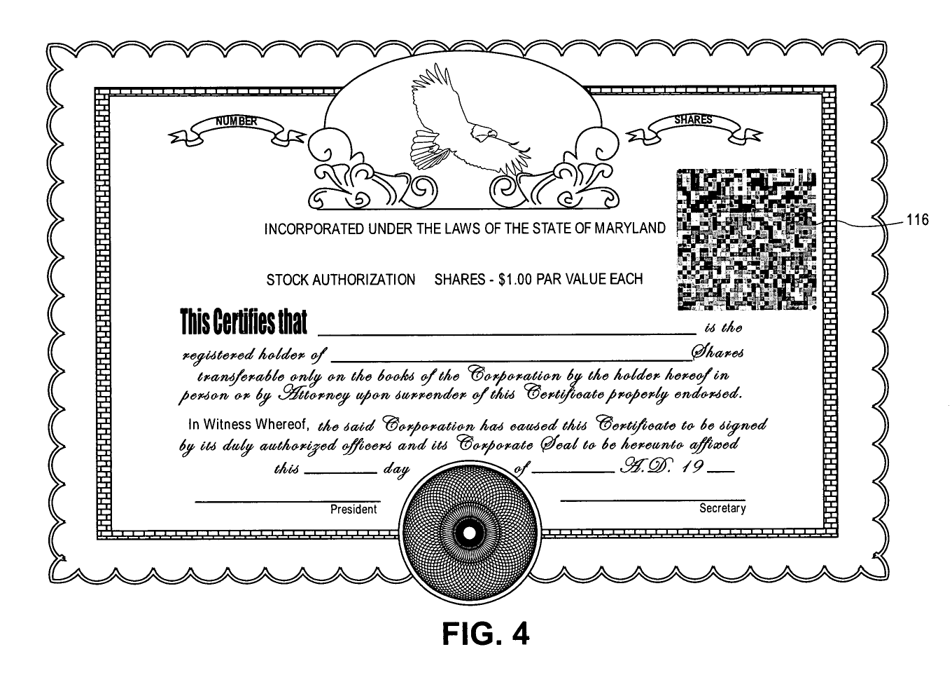

Colored barcode 116 may be part of various types of objects. For example, as noted above, barcode 116 may be part of paper currency, documents and images as well as credit card labeling. Other examples for barcode 116 may include drivers' licenses, passports, birth certificates, stock certificates, real property deeds, real property titles such as motor vehicle titles, identity documents, government benefit cards, certificates of naturalization, pharmaceuticals labeling, medical information cards, jewelry labeling, and packaging labeling. An example of barcode 116 is shown with reference to FIG. 2. Examples of a motor vehicle certificate and a stock certificate are shown with reference to FIGS. 3 and 4.

Referring now back to FIG. 1, computer 104 may be any device or system that is configured to read barcode 116. For example, computer 104 may include a scanner 118, a decoder application 120, and an interface application 122.

Scanner 118 may be implemented using a variety of known devices, such as a color camera, flat bed scanner, a handheld scanner, and the like. Such devices are well known to those skilled the art. Upon scanning barcode 116, scanner 118 may pass the information it collects to decoder application 120.

Decoder application 120 may be software executed by computer 104 to read and decode the information in barcode 116. For example, decoder application 120 may be coupled to a corresponding mapping table (not shown) that is identical to mapping 110. Decoder application 120 may then pass its information to interface application 122.

Interface application 122 may be software that is configured to reconstruct the information in barcode 116 into a suitable format. For example, interface application 122 may format the information in barcode 116 into a message or file that can be printed, manipulated by a word processor, stored, displayed, or transmitted.

FIG. 2 illustrates an example of a multi-colored barcode that is consistent with the present teachings. As shown, a barcode 200 may comprise a data region 202. In the embodiment shown, data region 202 may be bounded by markers 204 and 206 to indicate its boundaries. In addition, data region 202 may comprise colored tiles 208. In the embodiment shown, tiles 208 are shaped as squares. However, one skilled in the art will recognize that tiles 208 may be any form of polygon, such as a rectangle, triangle, and the like.

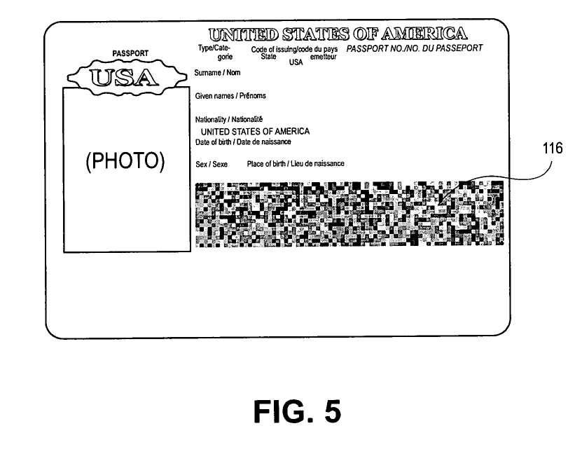

FIGS. 3-5 provide various examples of applications for the multi-colored barcode of the present teachings. FIG. 3 illustrates an exemplary motor vehicle certificate that incorporates a multi-colored barcode that is consistent with the present teachings. FIG. 4 illustrates an exemplary stock certificate that incorporates a multi-colored barcode that is consistent with the present teachings. FIG. 5 illustrates an exemplary page from a passport that incorporates a multi-colored barcode that is consistent with the present teachings.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

It is noted that, as used in this specification and the appended claims, the singular forms “a,” “an,” and “the,” include plural referents unless expressly and unequivocally limited to one referent. Thus, for example, reference to “a charged species” includes two or more different charged species. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to various embodiments described herein without departing from the spirit or scope of the present teachings. Thus, it is intended that the various embodiments described herein cover other modifications and variations within the scope of the appended claims and their equivalents.

1. A barcode comprising:
a data region comprising a set of tiles;
wherein each of the set of tiles is encoded with at least one of a plurality of colors;
wherein each character of a set of characters is represented by a respective color; and
wherein at least some of the plurality of colors represent combinations of characters from the set of characters.

2. The barcode of claim 1, wherein the data region comprises a set of marks that indicate boundaries of the data region.

3. The barcode of claim 1, wherein the data region is substantially rectangular in shape.

4. The barcode of claim 1, wherein the height of said data region ranges from about 0.5 to about 1.5 inches, and the width of said data region ranges from about 1 to about 4 inches.

5. The barcode of claim 1, wherein the set of tiles comprises polygons of a substantially uniform size, and said polygons are adjacent to each other.

6. The barcode of claim 1, wherein the set of tiles comprises squares of a substantially uniform size, and said squares are adjacent to each other.

7. The barcode of claim 1, wherein the set of tiles comprises rectangles of a substantially uniform size, and said rectangles are adjacent to each other.

8. The barcode of claim 1, wherein each character of the set of characters is represented by a combination of two or more tiles.

9. A method of encoding information into a barcode, wherein the barcode comprises a data region having a set of colored tiles, each character of a set of characters is represented by at least one respective color, and at least some colors represent combinations of characters from the set of characters, said method comprising:
determining information to be encoded into the barcode;
identifying characters and combinations of characters in the information;
selecting the respective colors that represent the identified characters and combinations of characters; and
formatting the data region to include the set of colored tiles based on the selected colors.

10. The method of claim 9, wherein selecting the respective colors that represent the identified characters and combinations of characters comprises retrieving a table having entries for each of the characters and combinations of characters, wherein each entry indicates a combination of two or more colors designated to represent the characters and combinations of characters.

11. The method of claim 9, wherein the table comprises entries for alphanumeric characters A through Z and 0 through 9.

12. The method of claim 9, wherein the table comprises entries for glyphs of written languages.

13. The method of claim 9, wherein the table comprises entries for at least one combination of characters, including at least one of the, ing, tion, qu, ton, and ion.

14. The method of claim 9, wherein formatting the data region to include the set of colored tiles based on the selected colors comprises formatting the data region such that colored tiles are located adjacent to each other.

15. A method of decoding information from a barcode, wherein the barcode comprises a data region having a set of colored tiles, said method comprising:
reading the data region of the barcode;
identifying the set of colored tiles in the data region;
determining a color of each of the set of colored tiles; and
determining at least one of a character or a combination of characters represented by the color of each colored tile.

16. The method of claim 15, wherein reading the data region of the barcode comprises:
illuminating the barcode with at least one source of light; and
detecting light reflected from the barcode.

17. The method of claim 15, wherein identifying the set of colored tiles in the data region comprises identifying each of the colored tiles based on a predetermined set of dimensions.

18. An object that contains information, said object comprising:
at least one printed surface that provides an area for presenting at least some of the information; and
a barcode that encodes at least some of the information within a data region having a set of colored tiles;
wherein each of the set of tiles is encoded with at least one of a plurality of colors, each character in the information is represented by a respective color, and at least some of the plurality of colors represent combinations of characters from the set of characters.

19. The object of claim 18, wherein the object contains information for at least one of a passport, a driver's license, birth certificate, stock certificate, real property deed, motor vehicle title, identity document, government benefit card, and certificate of naturalization.
